(19) United States
(12) Patent Application Publication
(10) Pub. No.: US 2014/0286657 A1
(43) Pub. Date: Sep. 25, 2014

(54) IMAGE FORMING APPARATUS AND METHOD OF FORMING TONER BAND

(71) Applicant: KONICA MINOLTA, INC., Tokyo (JP)

(72) Inventors: Yusuke NISHISAKA, Tokyo (JP); Satoshi NISHIDA, Saitama (JP)

(73) Assignee: KONICA MINOLTA, INC., Tokyo (JP)

(21) Appl. No.: 14/215,769

(22) Filed: Mar. 17, 2014

(30) Foreign Application Priority Data
Mar. 19, 2013 (JP) 2013-056404

(51) Int. Cl. G03G 15/00

(52) U.S. Cl. CPC G03G 21/0011
USPC 399/38; 399/44

(57) ABSTRACT

Disclosed herein is an image forming apparatus including: an image bearing member; an image forming section that forms a toner image on the image bearing member; a cleaning blade that makes contact with the image bearing member to remove toner on the image bearing member; and a control section that controls the image forming section to form a toner band on the image bearing member during a non-image formation period, the toner band being composed of toner to be provided to the cleaning blade, wherein the control section controls the image forming section to form the toner band on the image bearing member in such a manner that a toner concentration of the toner band on a downstream side in a rotational direction of the image bearing member is lower than an average concentration of the toner band.

### CROSS REFERENCE TO RELATED APPLICATIONS

This application is entitled and claims the benefit of Japanese Patent Application No. 2013-056404, filed on Mar. 19, 2013, the disclosure of which including the specification, drawings and abstract is incorporated herein by reference in its entirety.

### BACKGROUND OF THE INVENTION

1. Field of the Invention

The present invention relates to an image forming apparatus and a method of forming a toner band.

2. Description of Related Art

In an image forming apparatus of an intermediate transfer belt type and the like, a toner image formed on a photoconductor drum is temporarily transferred to an intermediate transfer belt, and then the toner image transferred on the intermediate transfer belt is transferred to a recording sheet. In this process, the toner is not completely transferred to the recording sheet, and remains on the surface of the intermediate transfer belt. The remaining toner hinders subsequent image formation processes, and as a result favorable transferred images may not be obtained. Under such circumstances, image forming apparatuses are provided with a cleaning device for removing toner.

In the above-mentioned cleaning device, cleaning blade 20 is brought into pressure contact with the surface of intermediate transfer belt 10 to remove the toner remaining on intermediate transfer belt 10, as illustrated in FIG. 7A. In the case where an image forming apparatus successively performs image formation, when the amount of toner which enters a portion where cleaning blade 20 makes pressure contact with intermediate transfer belt 10 (hereinafter referred to as “blade edge”) is small, the blade edge and the intermediate transfer belt do not smoothly slip, and as a result, the blade edge is dragged in the rotational direction of the intermediate transfer belt.

FIGS. 7B and 7C are enlarged views of the portion surrounded by the dotted line in FIG. 7A. FIG. 7B illustrates a state where blade edge 40 and intermediate transfer belt 10 slip favorably and blade edge 40 is not dragged by intermediate transfer belt 10. FIG. 7C illustrates a state where blade edge 40 and intermediate transfer belt 10 do not smoothly slip and blade edge 40 is dragged by intermediate transfer belt 10. When blade edge 40 is continuously dragged, cleaning blade 20 may be turned over and/or blade edge 40 may be abraded, thus degrading the cleaning performance.

In order to solve the above-mentioned problems, a technique has been proposed in which the action of lubricant contained in toner as an external additive is utilized, and a toner band (patch image) of a solid image, for example, is supplied to blade edge 40 of cleaning blade 20. The optimum amount of the toner of the toner band is determined according to the configuration of the cleaning device, the interval at which the toner band is supplied, and the like.

Japanese Patent Application Laid-Open No. 2012-123164 proposes a technique of forming a pattern of toner patches in which the amount of toner attached thereto is increased toward the downstream side in the conveyance direction of the intermediate transfer member in a non-image forming region of the intermediate transfer member, for the purpose of maintaining favorable slipping between a cleaning blade and an intermediate transfer member to decrease generation of chattering noise and to reduce cleaning defect.

Incidentally, in the state where blade edge 40 of cleaning blade 20 is dragged, the planar dimension of the portion where blade edge 40 touches intermediate transfer belt 10 increases, that is, the pressure contact force of blade edge 40 against intermediate transfer belt 10 decreases, and as a result, the cleaning performance of cleaning blade 20 decreases. Therefore, when a toner band is provided in the state where blade edge 40 is dragged, the toner band may not be sufficiently removed, and part of the toner band may pass therethrough.

When the toner band passes between cleaning blade 20 and intermediate transfer belt 10, in other words, when cleaning defect occurs, the following problems may occur: black-streak image noise may be generated when the remaining toner band is transferred onto the image formed by the next process; and image noise may be generated when the remaining toner band blocks light and consequently a potion where a latent image is not formed is formed in a light exposing step.

It is to be noted that, in the technique disclosed in Japanese Patent Application Laid-Open No. 2012-123164, the amount of toner in the pattern of toner patches is increased toward the downstream side in the conveyance direction of the intermediate transfer member. Therefore, when the pattern of toner patches is supplied in the state where the blade edge of the cleaning blade is dragged, it is highly possible that the pattern of toner patches on the downstream side is not sufficiently removed and allowed to pass therethrough.

### SUMMARY OF THE INVENTION

An object of the present invention is to provide an image forming apparatus capable of preventing a cleaning defect when a toner band is provided to a blade edge of a cleaning blade, and a method of forming the toner band.

To achieve the above-mentioned object, an image forming apparatus reflecting one aspect of the present invention includes an image bearing member; an image forming section that forms a toner image on the image bearing member; a cleaning blade that makes contact with the image bearing member to remove toner on the image bearing member; and a control section that controls the image forming section to form a toner band on the image bearing member during a non-image formation period, the toner band being composed of toner to be provided to the cleaning blade, wherein the control section controls the image forming section to form the toner band on the image bearing member in such a manner that a toner concentration of the toner band on a downstream side in a rotational direction of the image bearing member is lower than an average concentration of the toner band.

Desirably, in the image forming apparatus, the non-image formation period is an interval of recording sheets when the image forming apparatus successively performs image formation.

Desirably, in the image forming apparatus, the control section determines whether to form the toner band in accordance with at least one of a coverage of an image of a printing job performed by the image forming apparatus, and a temperature and a humidity around the image forming apparatus, and when the control section determines to form the toner band, the control section controls the image forming section to form the toner band on the image bearing member.

Desirably, in the image forming apparatus, the control section determines whether to form the toner band in accordance with change in driving torque of the image bearing member, and when the control section determines to form the toner band, the control section controls the image forming section to form the toner band on the image bearing member.

Desirably, in the image forming apparatus, the toner band includes a toner band on an upstream side and a toner band on a downstream side in the rotational direction of the image bearing member, and the toner band on the downstream side has a toner concentration lower than a toner concentration of the toner band on the upstream side.

Desirably, in the image forming apparatus, the toner concentration of the toner band increases stepwise or continuously toward an upstream side in the rotational direction of the image bearing member.

In a method of forming a toner band of an image forming apparatus reflecting one aspect of the present invention, the image forming apparatus includes: an image bearing member; an image forming section that forms a toner image on the image bearing member; a cleaning blade that makes contact with the image bearing member to remove toner on the image bearing member; and a control section that controls the image forming section to form a toner band on the image bearing member during a non-image formation period, the toner band being composed of toner to be provided to the cleaning blade, and the method includes controlling the image forming section to form the toner band on the image bearing member in such a manner that a toner concentration of the toner band on a downstream side in a rotational direction of the image bearing member is lower than an average concentration of the toner band.

Desirably, in the method, the non-image formation period is an interval of recording sheets when the image forming apparatus successively performs image formation.

Desirably, in the method, in the controlling, whether to form the toner band is determined in accordance with at least one of a coverage of an image of a printing job performed by the image forming apparatus, and a temperature and a humidity around the image forming apparatus, and when the control section determines to form the toner band, the control section controls the image forming section to form the toner band on the image bearing member.

Desirably, in the method, in the controlling, whether to form the toner band is determined in accordance with change in driving torque of the image bearing member, and when the control section determines to form the toner band, the control section controls the image forming section to form the toner band on the image bearing member.

Desirably, in the method, the toner band includes a toner band on an upstream side and a toner band on a downstream side in the rotational direction of the image bearing member, and the toner band on the downstream side has a toner concentration lower than a toner concentration of the toner band on the upstream side.

Desirably, in the method, the toner concentration of the toner band increases stepwise or continuously toward an upstream side in the rotational direction of the image bearing member.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1 illustrates a control block of an image forming apparatus of the present embodiment;

FIG. 2 illustrates a configuration of a cleaning device of the present embodiment;

FIG. 3 illustrates a control operation of the image forming apparatus of the present embodiment;

FIGS. 4A to 4D illustrate an exemplary toner band provided to a cleaning blade;

FIG. 5 illustrates a condition table for use in determining whether to form a toner band;

FIG. 6 illustrates a condition table for use in determining whether to form a toner band; and

FIGS. 7A to 7C are schematic views for use in explaining a problem of a conventional technology.

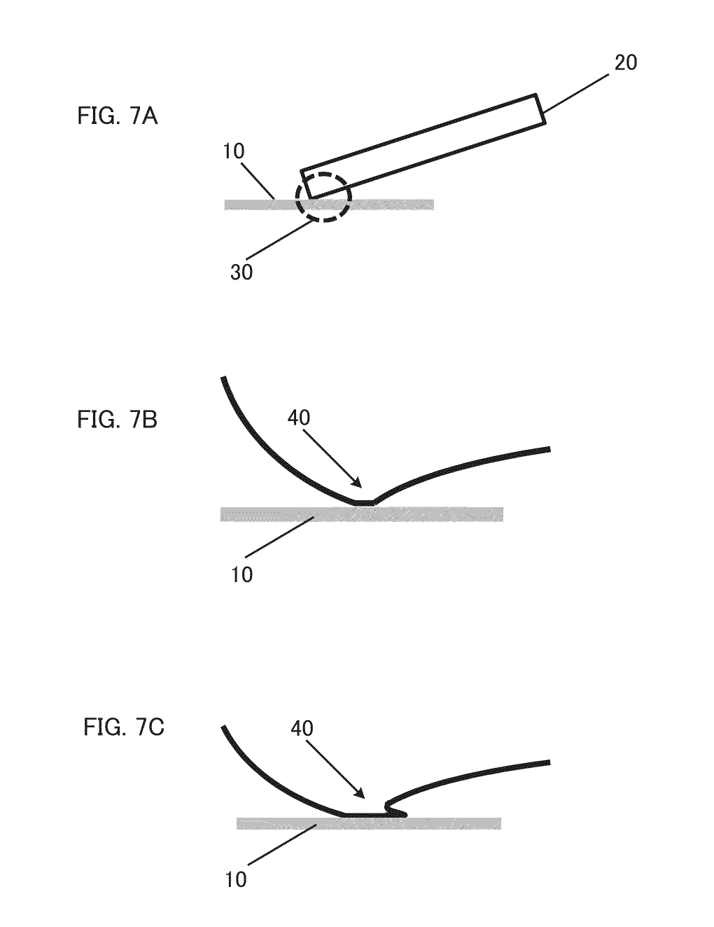

### DESCRIPTION OF THE PREFERRED EMBODIMENTS

In the following, an embodiment of the present invention is described in detail with reference to the drawings.

### Configuration of Image Forming Apparatus 100

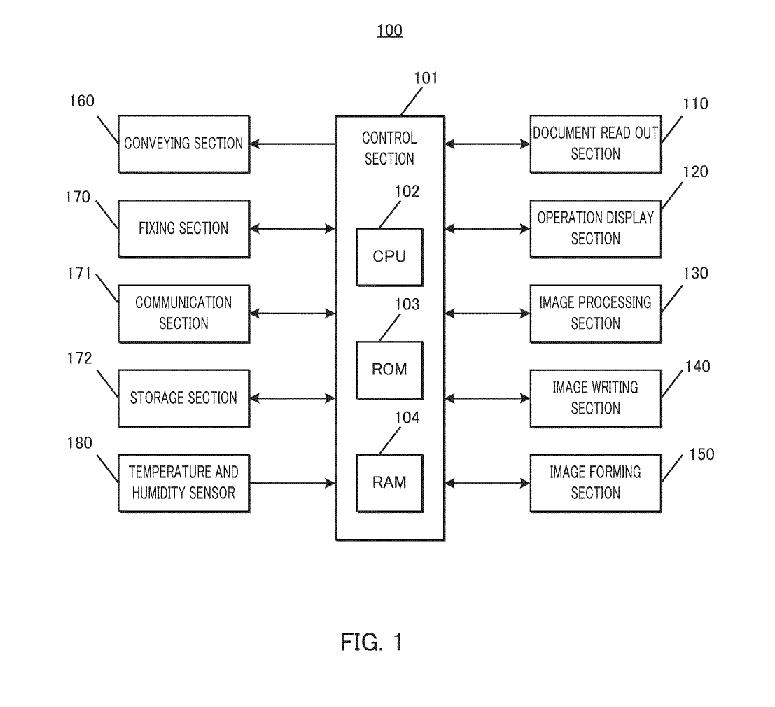

Image forming apparatus 100 illustrated in FIG. 1 forms an image on a recording sheet by the electrophotographic process. Image forming apparatus 100 includes control section 101, document read out section 110, operation display section 120, image processing section 130, image writing section 140, image forming section 150, conveying section 160, fixing section 170, communication section 171, storage section 172, and temperature and humidity sensor 180.

Control section 101 includes central processing unit (CPU) 102, read only memory (ROM) 103, random access memory (RAM) 104, and the like. CPU 102 reads out a program corresponding to processing details from ROM 103, loads the program in RAM 104, and performs a centralized control of operations of the blocks of image forming apparatus 100 in conjunction with the loaded program. At this time, various kinds of data stored in storage section 172 are referenced. Storage section 172 is composed of a nonvolatile-semiconductor memory (so-called flash memory) or a hard disk drive, for example.

Control section 101 exchanges various kinds of data, via communication section 171, with an external apparatus (for example, a personal computer) connected through a communication network such as local area network (LAN) and wide area network (WAN). For example, control section 101 receives image data (input image data) sent from the external apparatus, and forms an image on a recording sheet based on the received image data. Communication section 171 is composed of a communication control card such as a LAN card, for example.

Document read out section 110 optically scans a document conveyed onto a contact glass and brings light reflected from the document into an image on a light reception surface of charge coupled device (CCD) sensor, thereby reading out the image of the document. It is to be noted that, while the document is conveyed onto the contact glass by an automatic document paper feeder (ADF), the document may be manually placed on the contact glass.

Operation display section 120 includes a touch screen. Users can perform inputting operation for various kinds of instructions and settings from the touch screen.

Image processing section 130 includes a circuit for performing analog-to-digital (A/D) conversion processing and a circuit for performing digital image processing. Image processing section 130 performs A/D conversion processing on an analog image signal acquired by a CCD sensor of document read out section 110 to generate digital image data, and outputs the generated digital image data to image writing section 140.

Image writing section 140 emits laser light based on the digital image data generated by image processing section 130, and irradiates a photoconductor drum of image forming section 150 with the emitted laser light to form an electrostatic latent image on the photoconductor drum (light exposure step).

Image forming section 150 includes configurations for carrying out steps including, in addition to the above-mentioned light exposure step, a charging step that is performed prior to the light exposure step, a development step that is performed after the light exposure step, a transferring step subsequent to the development step, and a cleaning step subsequent to the transferring step. In the charging step, image forming section 150 uses corona discharging from a charging device to uniformly charge the surface of the photoconductor drum. In the development step, image forming section 150 causes toner contained in a developer in a developing device to adhere to an electrostatic latent image on the photoconductor drum, and thus forms a toner image on the photoconductor drum.

In the transferring step, image forming section 150 primary-transfers the toner image formed on the photoconductor drum to an intermediate transfer belt functioning as an image bearing member. In addition, image forming section 150 secondary-transfers the toner image formed on the intermediate transfer belt to a recording sheet conveyed by conveying section 160.

In the cleaning step, image forming section 150 brings a brush or the like into contact with the photoconductor drum to remove the toner which remains on the photoconductor drum after the transferring step. In addition, cleaning device 190 described later removes the toner which remains on the intermediate transfer belt after the transferring step.

Fixing section 170 includes a fixing roller and a pressure roller. The pressure roller is disposed in pressure contact with the fixing roller. A fixing nip portion is formed at a portion where the fixing roller and the pressure roller make pressure contact with each other. Fixing section 170 applies heat and pressure to a toner image on a recording sheet advanced into the fixing nip portion (thermal fixing) to thereby fix the toner image on the recording sheet (fixing step). As a result, a fixed toner image is formed on the recording sheet. The recording sheet having subjected to the thermal fixing by fixing section 170 is ejected out of image forming apparatus 100.

Temperature and humidity measuring section 180 measures the temperature and humidity around image forming apparatus 100. Every time the temperature and humidity around image forming apparatus 100 are measured, temperature and humidity measuring section 180 outputs temperature and humidity information pertaining to the temperature and humidity, to control section 101.

### Configuration of Cleaning Device 190

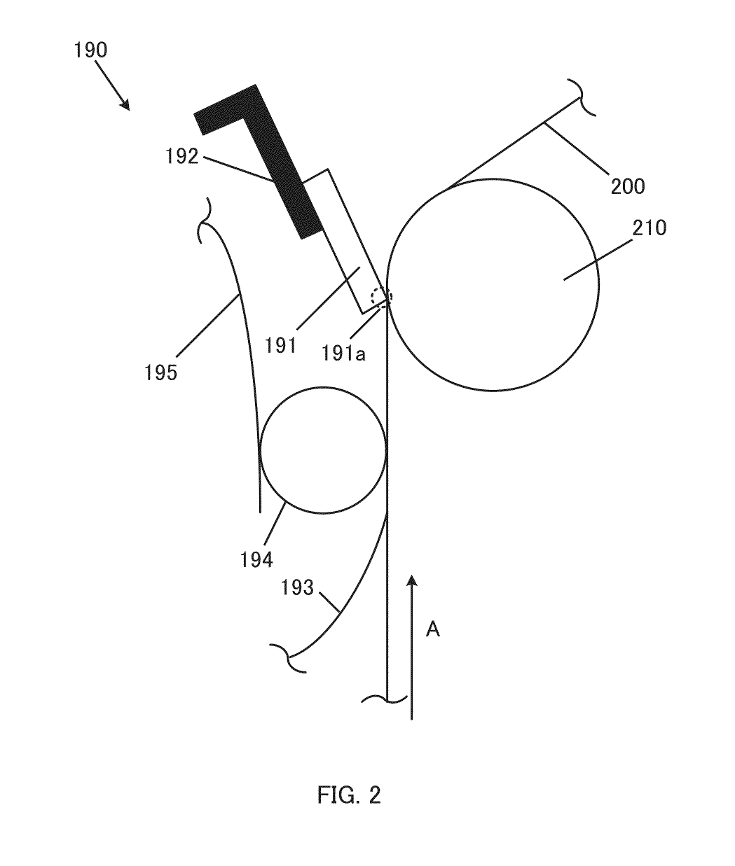

In the present embodiment, as illustrated in FIG. 2, cleaning device 190 is provided in the proximity of roller 210 that is one of a plurality of rollers around which intermediate transfer belt 200 is provided in a stretched state. Intermediate transfer belt 200 is an endless belt having a thickness of 70 [μm]. Intermediate transfer belt 200 is composed of a semiconductive belt made of polyimide (PI). When an image formation process is performed (or when a printing job is performed) in image forming apparatus 100, the intermediate transfer belt 200 is rotated clockwise (in arrow A direction) in the drawings at a predetermined rotation speed (for example, at 460 [mm/s]) in such a manner as to follow the rotation of the rollers around which intermediate transfer belt 200 is provided.

Cleaning device 190 includes cleaning blade 191, supporting sheet metal 192, Scattering prevention sheet 193, retention roller 194, retention sheet 195, and a casing (not illustrated). Cleaning blade 191, supporting sheet metal 192, Scattering prevention sheet 193, retention roller 194 and retention sheet 195 are provided in the casing.

Cleaning blade 191 is attached to supporting sheet metal 192 that supports cleaning blade 191. Cleaning blade 191 makes contact with the surface of intermediate transfer belt 200 to scrape and remove the toner which has not been secondary-transferred to a recording sheet and remains on the surface of intermediate transfer belt 200. The toner used herein is a polymerization toner having a particle size of 6.5 [μm].

At a position facing stretching roller 210, cleaning blade 191 brings blade edge 191a (edge) thereof into contact with the surface of intermediate transfer belt 200 in a direction against the rotational direction of intermediate transfer belt 200. Cleaning blade 191 is made of an elastic material such as, but not limited to, a urethane rubber (hardness: 74 [degrees] and impact resilience coefficient: 23[%]), for example. Cleaning blade 191 has a thickness of 2 [mm] Cleaning blade 191 has a free length of 9 [mm] The abutting load of cleaning blade 191 against intermediate transfer belt 200 is 25 [N/m].

Scattering prevention sheet 193 is composed of a flexible resin film, for example, and is provided at a position on the upstream side in the rotational direction of intermediate transfer belt 200, relative to blade edge 191a of cleaning blade 191 that makes contact with intermediate transfer belt 200. Scattering prevention sheet 193 prevents scattering of toner removed by cleaning blade 191 from the surface of intermediate transfer belt 200, in the casing. Further, one end of Scattering prevention sheet 193 is in close contact with the surface of intermediate transfer belt 200 so that the toner removed from the surface of intermediate transfer belt 200 is held in the casing to prevent the toner from spilling and leaking out of the casing.

In conjunction with intermediate transfer belt 200, retention roller 194 and retention sheet 195 retain the toner scraped by cleaning blade 191. Retention roller 194 and retention sheet 195 utilize the operation of intermediate transfer belt 200 to provide the toner retained therein to cleaning blade 191. To be more specific, part of the retained toner is conveyed to the upper side in the drawing by the rotation operation of intermediate transfer belt 200, and brought into contact with cleaning blade 191. Thus, the external additive contained in the toner is provided to cleaning blade 191.

Retention roller 194 is a roller having a diameter of 16 [mm] and made of foaming NBR (nitrile rubber). Retention roller 194 is provided on the upstream side in the rotational direction of intermediate transfer belt 200, relative to cleaning blade 191. In addition, retention roller 194 is provided in such a manner that the outer peripheral surface thereof makes sliding contact with intermediate transfer belt 200.

Retention sheet 195 is a sheet having a thickness of 0.1 [mm] and made of PET. Retention sheet 195 has flexibility, and part of retention sheet 195 is in contact with the surface of retention roller 194. Part of the toner removed by cleaning blade 191 passes between retention roller 194 and retention sheet 195, and drops to the bottom side in the drawing in the casing. By a conveying screw (not illustrated), the toner accumulated on the bottom side in the casing is collected in one place in cleaning device 190 and discarded.

### Control Operation of Image Forming Apparatus 100

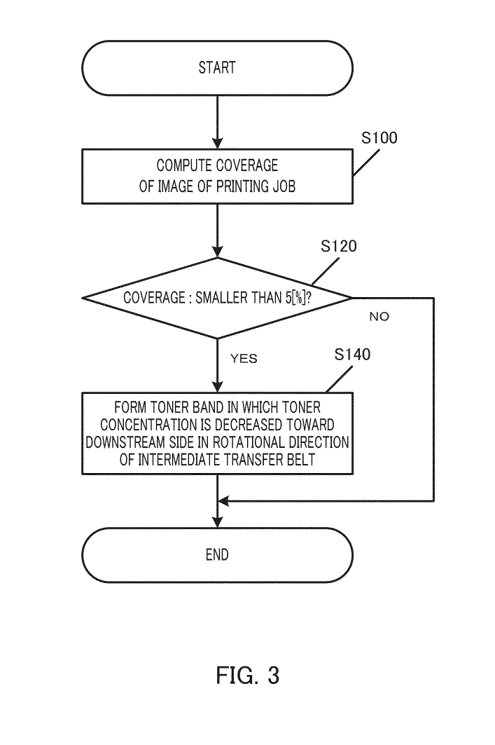

Next, referring to the flowchart of FIG. 3, the control operation of image forming apparatus 100 will be described. It is to be noted that each processing illustrated in FIG. 3 is performed during a non-image formation period such as an interval of recording sheets in the case where image forming apparatus 100 successively performs image formation, for example. An interval of recording sheets corresponds to a state where a recording sheet is not placed between secondary transfer NIP.

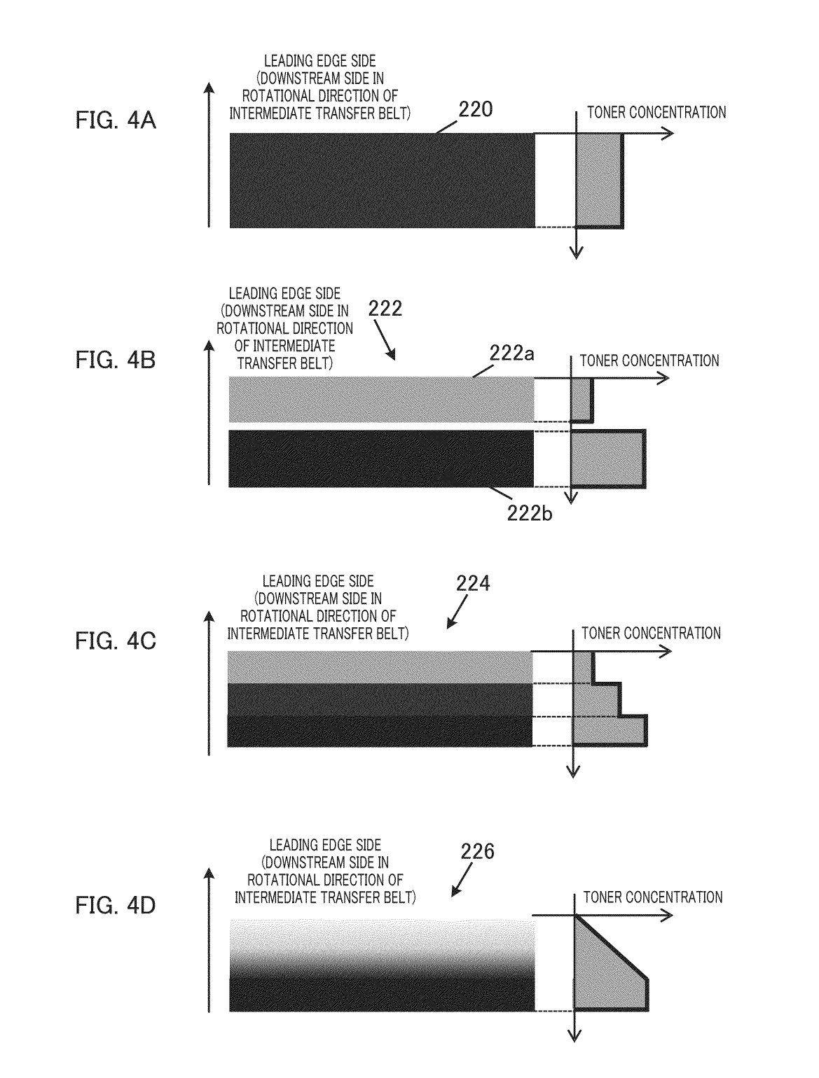

First, control section 101 computes the coverage of an image of a printing job performed by image forming apparatus 100 (step S100). The coverage is computed based on digital image data generated by image processing section 130. Next, control section 101 determines whether the computed coverage is smaller than 5[%] (step S120). When it is determined that the coverage is smaller than 5[%] (step S120, YES), control section 101 determines to form toner band 222 that is to be provided to cleaning blade 191, and controls image forming section 150 to form toner band 222 on intermediate transfer belt 200 (step S140). As illustrated in FIG. 4B, in toner band 222, the toner concentration on the downstream side in the rotational direction of intermediate transfer belt 200 is lower than the average concentration thereof Upon completion of the processing of step S140, image forming apparatus 100 terminates the processing of FIG. 3.

Toner band 222 includes two toner bands 222a and 222b which are positioned on the upstream side and the downstream side in the rotational direction of intermediate transfer belt 200. The toner concentration of toner band 222a positioned on the downstream side is lower than that of toner band 222b positioned on the upstream side. Toner band 222 formed on intermediate transfer belt 200 is provided to cleaning blade 191.

When the coverage is smaller than 5[%], blade edge 191a of cleaning blade 191 slides on intermediate transfer belt 200 more frequently, and as a result, the sliding between blade edge 191a and intermediate transfer belt 200 becomes worse. Consequently, blade edge 191a is dragged in the rotational direction of intermediate transfer belt 200. When blade edge 191a is continuously dragged, cleaning blade 191 may be turned over, or blade edge 191a may be abraded, thus degrading the cleaning performance.

Conventionally, toner band 220 having a uniform toner concentration as illustrated in FIG. 4A is provided to cleaning blade 191 to utilize the action of lubricant contained in the toner as an external additive. However, when blade edge 191a of cleaning blade 191 is dragged, the pressure contact force of blade edge 191a against intermediate transfer belt 200 decreases, and as a result, the cleaning performance of cleaning blade 191 decreases. Therefore, when toner band 220 is provided in the state where blade edge 191a is dragged, toner band 220 may not be sufficiently removed and consequently part of toner band 220 may undesirably pass therethrough.

The state where blade edge 191a is dragged is cleared when toner band 220 is provided to blade edge 191a. That is, the cleaning performance of cleaning blade 191 is restored. However, when toner band 220 having a high concentration is provided before the cleaning performance of cleaning blade 191 is restored, toner band 220 cannot be sufficiently removed, and thus part of toner band 220 (in particular, the leading edge side thereof) undesirably passes therethrough.

In view of the above, in the present embodiment, toner band 222 in which the toner concentration on the downstream side in the rotational direction of intermediate transfer belt 200 is lower than the average concentration thereof is provided, whereby toner band 222a having a lower toner concentration is provided until the state where blade edge 191a is dragged is cleared so that the dragging state can be cleared. After the state where blade edge 191a is dragged is cleared and the cleaning performance of cleaning blade 191 is restored, toner band 222b having a higher toner concentration (for example, a solid concentration) is provided.

Meanwhile, when the coverage is not smaller than 5[%], that is, when the coverage is equal to or greater than 5[%] (step S120, NO), image forming apparatus 100 terminates the processing of FIG. 3.

It is to be noted that, as modifications of the toner band to be provided to cleaning blade 191, it is also possible to form toner band 224 in which the toner concentration is increased stepwise toward the upstream side in the rotational direction of intermediate transfer belt 200 as illustrated in FIG. 4C, or toner band 226 in which the toner concentration is continuously increased toward the upstream side in the rotational direction of intermediate transfer belt 200 as illustrated in FIG. 4D. It is preferable to shorten the length of the toner band in the rotational direction of intermediate transfer belt 200 as much as possible by providing a portion having a toner concentration higher than that of the conventional technique in regions other than the region on the leading edge side. One reason for this is to avoid decrease in productivity.

The total toner amount (the planar dimension of the portion indicated by gray hatching in FIGS. 4A to 4D) of each of toner bands 220, 222, 224 and 226 illustrated in FIGS. 4A to 4D is set at the same amount. One reason for this is that a certain amount of toner is required to clear the state where blade edge 191a is dragged. In addition, while toner bands 220, 222, 224 and 226 illustrated in FIGS. 4A to 4D are formed by using only black, a combination of different colors may be used to form toner bands 220, 222, 224 and 226 in the case where image forming apparatus 100 is a full color image forming apparatus, from the perspective of making the toner consumption amount of the colors as even as possible.

### Effect of the Present Embodiment

As has been described in detail, image forming apparatus 100 of the present embodiment includes: intermediate transfer belt 200; image forming section 150 that forms a toner image on intermediate transfer belt 200; cleaning blade 191 that makes contact with intermediate transfer belt 200 to remove the toner on intermediate transfer belt 200; and control section 101 that controls image forming section 150 to form toner bands 222, 224 and 226 on intermediate transfer belt 200 which are to be provided to cleaning blade 191 during a non-image formation period, wherein control section 101 controls image forming section 150 to form, on intermediate transfer belt 200, a toner band having a toner concentration lower than the average concentration of toner bands 222, 224 and 226 on the downstream side in the rotational direction of intermediate transfer belt 200. In addition, control section 101 determines whether to form toner bands 222, 224 and 226 according to the coverage of an image of a printing job performed by image forming apparatus 100, and when it is determined to form toner bands 222, 224 and 226, control section 101 controls image forming section 150 to form toner bands 222, 224 and 226 on intermediate transfer belt 200.

In the above-mentioned configuration of the present embodiment, a toner band having a low toner concentration is provided until the state where blade edge 191a is dragged is cleared. In this manner, it is possible to prevent an undesirable situation where a provided toner band is not sufficiently removed and thus part of the toner band (in particular, the leading edge side thereof) passes therethrough. In other words, cleaning defect can be prevented.

### Modification

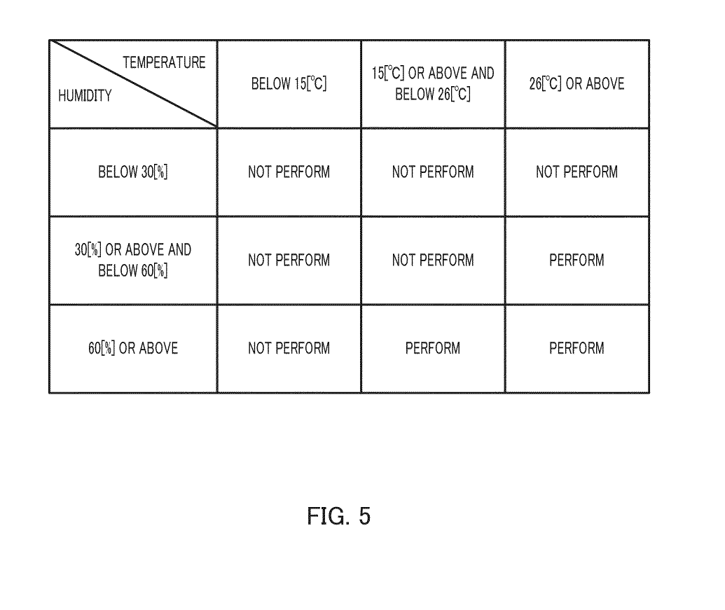

It is to be noted that, in the above-mentioned embodiment, control section 101 may determine whether to form toner bands 222, 224 and 226 according to the temperature and humidity around image forming apparatus 100 by referring temperature and humidity information output by temperature and humidity measuring section 180. One reason for this is that, particularly in an environment of high temperature and high humidity, the material of the blade is susceptible to softening and deformation, and blade edge 191a of cleaning blade 191 is susceptible to dragging. Control section 101 may determine whether to form toner bands 222, 224 and 226 according to the condition table illustrated in FIG. 5. In this case, control section 101 determines to form toner bands 222, 224 and 226 when the temperature and humidity indicated by the temperature and humidity information output by temperature and humidity measuring section 180 correspond to “perform” in the condition table of FIG. 5.

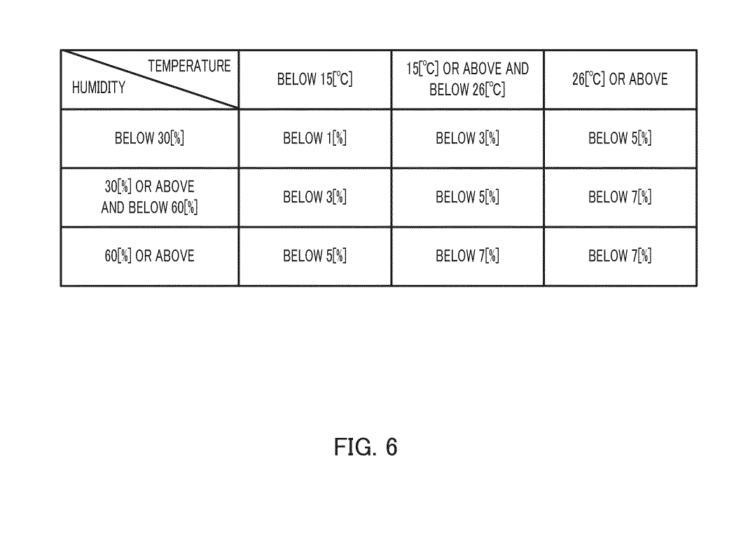

In addition, in the above-mentioned embodiment, control section 101 may determine whether to form toner bands 222, 224 and 226 according to the temperature and humidity environment around image forming apparatus 100, and the coverage of an image of the printing job performed by image forming apparatus 100. Control section 101 may determine whether to form toner bands 222, 224 and 226 according to the condition table illustrated in FIG. 6. In this case, control section 101 determines to form toner bands 222, 224 and 226 when the coverage satisfies the condition of the item which is derived from the temperature and humidity in the condition table of FIG. 6 (for example, below 5[%] when the temperature is 15[° C.] or above and below 26[° C.], and the humidity is 30[%] or above and below 60[%]). For example, control section 101 determines to form toner bands 222, 224 and 226 when the temperature and humidity are respectively 26[° C.] or above and 60[%] or above, and the coverage is smaller than 7[%]. In addition, control section 101 determines to form toner bands 222, 224 and 226 when the temperature and humidity are respectively below 15[° C.] and below 30[%], and the coverage is smaller than 1[%].

In addition, in the above-mentioned embodiment, control section 101 may determine whether to form toner bands 222, 224 and 226 according to change in driving torque of intermediate transfer belt 200. One reason for this is that it is possible to determine that blade edge 191a has been dragged when the driving torque of intermediate transfer belt 200 is increased during the image formation in comparison with the driving torque at the time immediately after the start of successive image formations performed by image forming apparatus 100, for example.

In addition, while, in the above-mentioned embodiment, intermediate transfer belt 200 functions as the image bearing member of the embodiment of the present invention, the present invention is not limited thereto. For example, a photoconductor, a transfer belt and the like, which make contact with cleaning blade 191 for removing remaining toner, may also function as the image bearing member of the embodiment of the present invention.

The embodiment disclosed herein is merely an exemplification and should not be considered as limitative. While the invention made by the present inventor has been specifically described based on the preferred embodiments, it is not intended to limit the present invention to the above-mentioned preferred embodiments but the present invention may be further modified within the scope and spirit of the invention defined by the appended claims.

What is claimed is:

1. An image forming apparatus comprising:
an image bearing member;
an image forming section that forms a toner image on the image bearing member;
a cleaning blade that makes contact with the image bearing member to remove toner on the image bearing member; and
a control section that controls the image forming section to form a toner band on the image bearing member during a non-image formation period, the toner band being composed of toner to be provided to the cleaning blade, wherein
the control section controls the image forming section to form the toner band on the image bearing member in such a manner that a toner concentration of the toner band on a downstream side in a rotational direction of the image bearing member is lower than an average concentration of the toner band.

2. The image forming apparatus according to claim 1, wherein the non-image formation period is an interval of recording sheets when the image forming apparatus successively performs image formation.

3. The image forming apparatus according to claim 1, wherein
the control section determines whether to form the toner band in accordance with at least one of a coverage of an image of a printing job performed by the image forming apparatus, and a temperature and a humidity around the image forming apparatus, and
when the control section determines to form the toner band, the control section controls the image forming section to form the toner band on the image bearing member.

4. The image forming apparatus according to claim 1, wherein
the control section determines whether to form the toner band in accordance with change in driving torque of the image bearing member, and
when the control section determines to form the toner band, the control section controls the image forming section to form the toner band on the image bearing member.

5. The image forming apparatus according to claim 1, wherein
the toner band includes a toner band on an upstream side and a toner band on a downstream side in the rotational direction of the image bearing member, and
the toner band on the downstream side has a toner concentration lower than a toner concentration of the toner band on the upstream side.

6. The image forming apparatus according to claim 1, wherein the toner concentration of the toner band increases stepwise or continuously toward an upstream side in the rotational direction of the image bearing member.

7. A method of forming a toner band of an image forming apparatus, the image forming apparatus including:
an image bearing member;
an image forming section that forms a toner image on the image bearing member;
a cleaning blade that makes contact with the image bearing member to remove toner on the image bearing member; and
a control section that controls the image forming section to form a toner band on the image bearing member during a non-image formation period, the toner band being composed of toner to be provided to the cleaning blade,
the method comprising
controlling the image forming section to form the toner band on the image bearing member in such a manner that a toner concentration of the toner band on a downstream side in a rotational direction of the image bearing member is lower than an average concentration of the toner band.

8. The method according to claim 7, wherein the non-image formation period is an interval of recording sheets when the image forming apparatus successively performs image formation.

9. The method according to claim 7, wherein,
in the controlling, whether to form the toner band is determined in accordance with at least one of a coverage of an image of a printing job performed by the image forming apparatus, and a temperature and a humidity around the image forming apparatus, and
when the control section determines to form the toner band, the control section controls the image forming section to form the toner band on the image bearing member.

10. The method according to claim 7, wherein,
in the controlling, whether to form the toner band is determined in accordance with change in driving torque of the image bearing member, and
when the control section determines to form the toner band, the control section controls the image forming section to form the toner band on the image bearing member.

11. The method according to claim 7, wherein
the toner band includes a toner band on an upstream side and a toner band on a downstream side in the rotational direction of the image bearing member, and
the toner band on the downstream side has a toner concentration lower than a toner concentration of the toner band on the upstream side.

12. The method according to claim 7, wherein the toner concentration of the toner band increases stepwise or continuously toward an upstream side in the rotational direction of the image bearing member.
